(19) United States
(12) Patent Application Publication
(10) Pub. No.: US 2003/0056124 A1
(43) Pub. Date: Mar. 20, 2003

(54) Digital-based mechanism for determining voltage

(76) Inventors: Brian W. Amick, Austin, TX (US); Claude R. Gauthier, Fremont, CA (US)

Correspondence Address: Jonathan P Osha, ROSENTHAL & OSHA LLP, 700 Louisiana Street, Suite 4550, Houston, TX, 77002, US

(21) Appl. No.: 09/955,681

(22) Filed: Sep. 19, 2001

(51) Int. Cl. G06F 1/26; G06F 1/28; G06F 1/30

(52) U.S. Cl. 713/300

(57) ABSTRACT

An on-chip voltage sensor that uses a voltage controlled oscillator to determine actual voltage on a section of a computer chip is provided. By knowing an expected voltage controlled oscillator frequency at a specific section of a computer chip, actual voltage may be determined by using an actual voltage controlled oscillator frequency at that specific section. Further, a method for measuring voltage on-chip using a voltage controlled oscillator is provided. Further, an integrated circuit having a voltage sensor that measures a voltage at a section of the integrated circuit is provided.

### BACKGROUND OF INVENTION

The performance of a computer chip (also referred to and known as “integrated circuit”) varies with the voltages, temperatures, and process corners at different points on the computer chip. Accurately knowing these parameters helps chip designers understand and improve chip behavior.

For example, if a voltage supply level for a clock tree is low, the clock tree loses its drive strength, and the integrity of clock signals throughout a computer chip may deteriorate. Thus, it is important to know voltages at particular points on the computer chip to ensure that performance inhibiting behavior is compensated for and/or avoided in chip design.

One approach used by chip designers to monitor voltage on a computer chip involves the allocation of sense points on the computer chip. These sense points are then attached to a trace, or wire, that leads to an exterior area, such as the circuit board, of the computer chip. However, this type of voltage measurement is prone to inaccuracy because the measurement of the voltage on the chip attenuates as the measurement transfers to an area outside the computer chip. Further, such a voltage measurement is also susceptible to high-frequency noise that exists on both on-chip and off-chip wires.

Alternatively, chip designers can physically probe different regions within the computer chip. However, this technique is becoming increasingly difficult because empty space within a computer chip is decreasing as modern computer chips become smaller and more device-laden. In cases when physical probing is not feasible, voltage is assumed to be within a certain range.

### SUMMARY OF INVENTION

According to one aspect of the present invention, a voltage sensor that measures voltage at a section of an integrated circuit comprises a voltage controlled oscillator disposed on the integrated circuit, a first counter stage disposed on the integrated circuit that counts a number of pulses generated by the voltage controlled oscillator, and a second counter stage disposed on the integrated circuit that counts a number of pulses on a clock signal, where a count of the first counter stage relative to an expected count represents an actual voltage at the section of the integrated circuit.

According to another aspect, a method for measuring voltage at a section of an integrated circuit comprises counting pulses generated by a voltage controlled oscillator, counting pulses on a clock signal, and comparing a count of pulses generated by the voltage controlled oscillator and a count of pulses on the clock signal to determine the voltage at the section of the integrated circuit.

According to another aspect, a voltage sensor comprises a voltage controlled oscillator disposed on the integrated circuit, a first counter stage disposed on the integrated circuit that counts a number of pulses generated by the voltage controlled oscillator, and a second counter stage disposed on the integrated circuit that counts a number of pulses on a clock signal, where a count of the first counter stage relative to an expected count represents an actual voltage at the section of the integrated circuit.

Other aspects and advantages of the invention will be apparent from the following description and the appended claims.

### BRIEF DESCRIPTION OF DRAWINGS

FIG. 1 shows a circuit diagram of an on-chip voltage sensor in accordance with an embodiment of the present invention.

FIG. 2a shows an exemplary flow process in accordance with the embodiment shown in FIG. 1.

FIG. 2b shows an exemplary flow process in accordance with the embodiment shown in FIG. 1.

FIG. 3 shows a relationship between time and a count of VCO pulses in accordance an embodiment of the present invention.

### DETAILED DESCRIPTION

The present invention relates to an on-chip voltage sensor that determines an average power supply voltage at a section of a computer chip. The present invention also relates to a method for determining an average power supply voltage at a section of a computer chip.

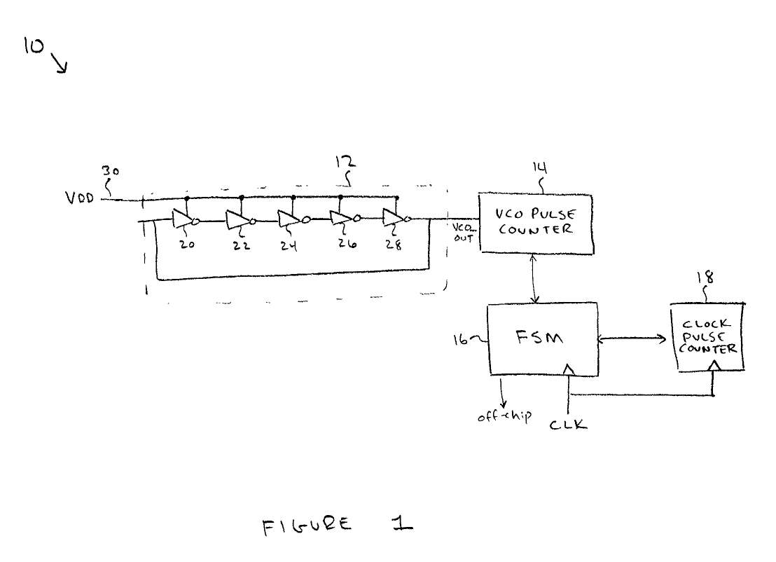

FIG. 1 shows an exemplary circuit diagram of an on-chip voltage sensor (10) in accordance with an embodiment of the present invention. The on-chip voltage sensor (10) has a voltage controlled oscillator (“VCO”) (12), a VCO pulse counter stage (also referred to as “first counter stage”) (14), a finite state machine (“FSM”) (16), and a clock pulse counter stage (also referred to as “second counter stage”) (18). The VCO (12) is formed by an odd number of inverters (20, 22, 24, 26, 28) placed in series, in which an output of the last inverter (28) serves as an input to the first inverter (20). Each of the inverters (20, 22, 24, 26, 28) is powered by a voltage supply (“VDD”) (30) of the computer chip on which the on-chip voltage sensor (10) resides. Those skilled in the art will note the frequency of the VCO (12) may vary with VDD with respect to a particular temperature and process corner. For example, if the temperature and process corner at a particular section of the computer chip are known at a particular time, the voltage at that section may determined by ascertaining how much higher or lower the frequency of the VCO is with respect to an expected value.

The VCO (12) outputs a clock-like signal, VCO_OUT, to the VCO pulse counter stage (14). The VCO pulse counter stage (14) counts the number of pulses on VCO_OUT.

The clock pulse counter stage (18) counts the number of pulses on a clock signal, CLK, of the computer chip on which the on-chip voltage sensor resides. When the clock pulse counter stage (18) counts a specified number of pulses, the clock pulse counter stage (18) sends a signal to the finite state machine (16), which is also clocked by CLK. The finite state machine (16) then immediately queries the count of the VCO pulse counter stage (14) and resets the VCO pulse counter stage (14).

The finite state machine (16) then sends the VCO pulse counter stage (14) count off-chip. This VCO pulse counter stage (14) count is then compared to an expected value and a determination may be made as to the voltage at the section of the computer chip on which the on-chip voltage sensor (10) resides. Those skilled in the art will appreciate that this determination may also be made on-chip.

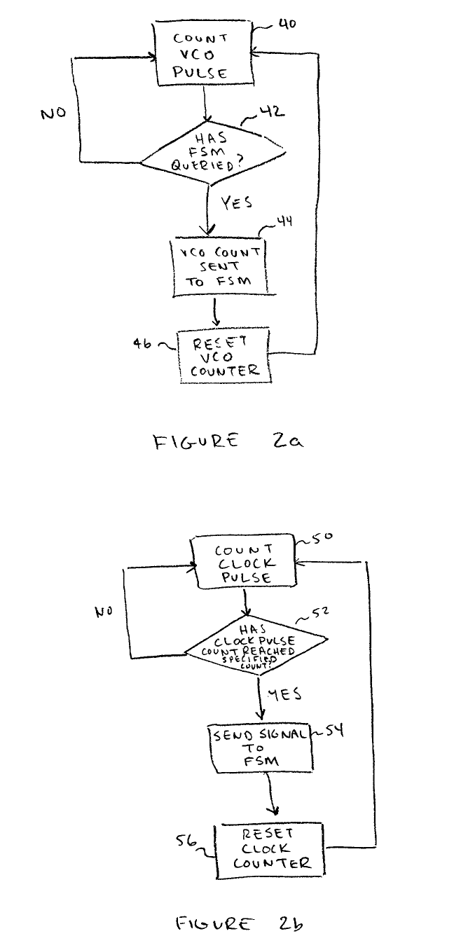

FIGS. 2a and 2b show exemplary flow processes in accordance with the embodiment shown in FIG. 1. Particularly, FIG. 2a shows the flow process for the VCO pulse counter stage (14) and FIG. 2b shows the flow process for the clock pulse counter stage (18). Referring to FIG. 2a, the VCO pulse counter stage (14) counts a pulse on VCO_OUT (this count is referred to as “VCO counter stage count”) (step 40). Next, if the finite state machine (16) queries the VCO pulse counter stage (14) (step 42), the VCO counter stage count is transferred to the finite state machine (16) (step 44), after which, the VCO counter stage count is reset (step 46). However, if the finite state machine (16) does not query the VCO pulse counter stage (14) (step 42), the VCO pulse counter stage (14) returns to count the next pulse on VCO_OUT (step 40).

Referring to FIG. 2b, the clock pulse counter stage (18) counts a pulse on CLK (this count is referred to as “clock counter stage count”) (step 50). Next, a determination is made as to whether the clock pulse counter stage (18) has reached a specified clock counter stage count (step 52). If the clock pulse counter stage (18) has not reached the specified clock counter stage count (step 52), the clock pulse counter stage (18) returns to count the next pulse on CLK (step 50). However, if the clock pulse counter stage (18) does reach the specified clock counter stage count, the clock pulse counter stage (18) sends a signal to the finite state machine (16) to indicate that a specified amount of time has elapsed and that the VCO pulse counter stage (14) needs to be queried (step 54). Thereafter, the clock counter stage count is reset (step 56).

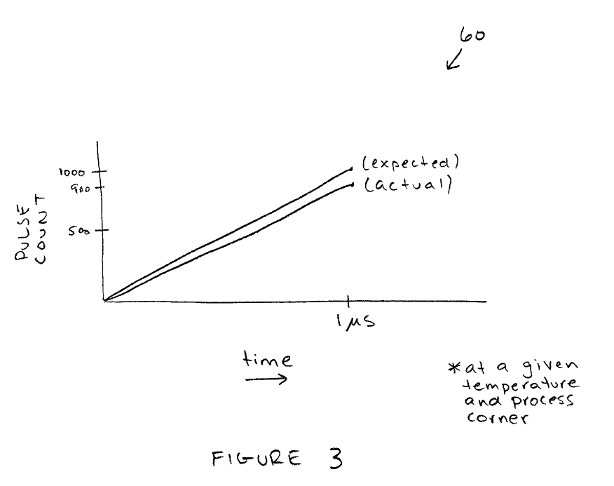

FIG. 3 shows an exemplary relationship (60) between time and expected and actual counts of VCO pulses in accordance with an embodiment of the present invention. Given or knowing a particular temperature and process corner at a section of a computer chip at a particular time, if an expected count of VCO pulses during a microsecond (time determined by clock pulse counter stage (18) (shown in FIG. 1)) of an on-chip voltage sensor's operation is 1,000 (shown in FIG. 3), and an actual count of VCO pulses during that microsecond is 900 (shown in FIG. 3), then the voltage may be determined by looking up a voltage value corresponding to 900 pulses for that particular temperature and process corner. Thus, if an expected voltage at the section of a computer chip on which the on-chip voltage sensor (10) resides is 1.2 volts, the actual voltage is likely lower than 1.2 volts, e.g., 0.8 volts. Those skilled in the art will appreciate that although the relationship discussed above with reference to FIG. 3 is linear, the relationship may be non-linear in other embodiments of the present invention.

Advantages of the present invention may include one or more of the following. In some embodiments, because a voltage sensor may be used on-chip, a voltage at a section of a computer chip may be accurately determined.

In some embodiments, because voltage at a section of a computer chip may be accurately determined with an on-chip voltage sensor, chip performance and efficiency may be increased.

In some embodiments, because voltage at a section of a computer chip may be determined, power grid integrity may be improved through design.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A voltage sensor that measures voltage at a section of an integrated circuit, comprising:
a voltage controlled oscillator disposed on the integrated circuit;
a first counter stage disposed on the integrated circuit that counts a number of pulses generated by the voltage controlled oscillator; and
a second counter stage disposed on the integrated circuit that counts a number of pulses on a clock signal, wherein a count of the first counter stage relative to an expected count represents an actual voltage at the section of the integrated circuit.

2. The voltage sensor of claim 1, further comprising:
a finite state machine disposed on the integrated circuit that queries the count of the first counter stage when the second counter stage reaches a specified count.

3. A method for measuring voltage at a section of an integrated circuit, comprising:
counting pulses generated by a voltage controlled oscillator;
counting pulses on a clock signal; and
comparing a count of pulses generated by the voltage controlled oscillator and a count of pulses on the clock signal to determine the voltage at the section of the integrated circuit.

4. The method of claim 3, further comprising:
querying the count of the pulses generated by the voltage controlled oscillator when a specified count of pulses on the clock signal has been reached.

5. The method of claim 4, further comprising:
notifying a finite state machine when a specified count of pulses on the clock signal has been reached, where after the finite state machine queries the count of the pulses generated by the voltage controlled oscillator.

6. The method of claim 3, wherein the voltage controlled oscillator operates at an expected voltage.

7. The method of claim 6, wherein the queried count of pulses generated by the voltage controlled oscillator is compared to an expected count of pulses to determine an actual voltage, and wherein the expected count of pulses varies with the expected voltage.

8. The method of claim 3, further comprising:
resetting the count of the pulses generated by the voltage controlled oscillator once the count of the pulses generated by the voltage controlled oscillator has been queried.

9. An integrated circuit having a voltage sensor that measures voltage at a section of the integrated circuit, the voltage sensor comprising:
a voltage controlled oscillator disposed on the integrated circuit;
a first counter stage disposed on the integrated circuit that counts a number of pulses generated by the voltage controlled oscillator; and
a second counter stage disposed on the integrated circuit that counts a number of pulses on a clock signal, wherein a count of the first counter stage relative to an expected count is used to determine an actual voltage at the section of the integrated circuit.

10. The integrated circuit of claim 9, further comprising:
a finite state machine disposed on the integrated circuit that queries the count of the first counter stage when the second counter stage reaches a specified count.
